(19) United States
(12) Patent Application Publication
(10) Pub. No.: US 2016/0303721 A1
(43) Pub. Date: Oct. 20, 2016

(54) SWITCHABLE PLIERS

(71) Applicant: A & E Incorporated, Racine, WI (US)

(72) Inventors: JONATHAN L. LUDTKE, WATERFORD, WI (US); JEFFREY J. KUZMIC, WIND LAKE, WI (US)

(73) Assignee: A&E INCORPORATED, RACINE, WI (US)

(21) Appl. No.: 14/689,393

(22) Filed: Apr. 17, 2015

(51) Int. Cl. B25B 27/20; B25B 7/10

(52) U.S. Cl. CPC B25B 27/205; B25B 7/10

(57) ABSTRACT

A pliers switchable for use with external snap-rings and internal snap-rings. The pliers has a first member with an aperture, a second member with an offset V-shape track, and a pin with two parallel straight sides and two opposing outwardly curved sides. The pin is received within the aperture and the offset V-shape track and is moveable within the offset V-shape track.

### RELATED APPLICATIONS

This application claims the benefit of co-pending U.S. Provisional Patent Application Ser. No. 61/980,944, filed on 17 Apr. 2014.

### BACKGROUND OF THE INVENTION

Pliers, specifically snap-ring pliers are well known in the art. Snap-rings can be either “internal” or “external.” In their neutral state, internal snap-rings are generally disposed in a slightly open-loop configuration. They may be used to retain a part within a cylinder, for example, retaining a bearing in a shaft. To install an internal snap-ring the open-loop end is closed to decrease the diameter to fit within the cylinder. The snap-ring is then allowed to open within the cylinder, ideally within a groove. On the other hand, external snap-rings may be used to retain an object on the external side of a shaft, for example, gears or pulleys on a shaft. External snap-rings are generally disposed in a closed-loop configuration. The closed-loop may be spread open to permit the external snap-ring to fit over a shaft, then once in place, the external snap-ring may be released, preferably in a groove about the shaft, to retain the object on the shaft.

Generally, there are internal snap-ring pliers used to install internal snap-rings and external snap-ring pliers to install external snap-rings. Internal snap-ring pliers may consist of a pair of handles which cross at a pivot pin and with a tip at the snap-ring interface end. The crossing configuration allows a closing action of the handles to translate into a closing action of the tips, thus a closing of the open-loop of the internal snap-ring. External snap-ring pliers may consist of a pair of handles connected at a pivot point but do not cross at the pivot point. This configuration allows a closing action of the handles to translate into an opening of the tips, thus spreading the external snap-ring.

Additionally, there are internal/external snap-ring pliers which allow a user to switch between an orientation for use with internal snap-rings and an orientation for use with an external snap-ring. Some switchable devices provide a first handle with a pivot pin affixed to it and a second handle with a V-shape track in which the first handle pin travels within. However, in some orientations during use, one of the handles will be displaced relative to the other due to the orientation of the pin and the groove and the spring force exhibited by a biased snap-ring. This will either twist the snap-ring, making alignment with the groove more difficult, or cause the pliers to disengage from one end of the snap-ring entirely. Accordingly, the art of snap-ring pliers could benefit from a more reliably engaged device capable of easily switching from an internal to external snap-ring pliers.

### SUMMARY OF THE INVENTION

The present invention relates to a more reliably engaged switchable pliers which may be used with both internal and external snap-rings. The pliers has a first member with an aperture, a second member with an offset V-shape track, and a pin with two parallel straight sides and two opposing outwardly curved sides. The pin is received within the aperture and the offset V-shape track and is moveable within the offset V-shape track.

One aspect of the invention provides a pliers having a first member with a first member handle, a first member tip, and a first member medial portion between the first member handle and the first member tip; the first member medial portion has an aperture comprising two opposed outwardly curved sides connected by two opposed straight sides; a second member with a second member handle, a second member tip, and a second member medial portion between the second member handle and the second member tip; the second member medial portion has an offset V-shape track; a pin with a threaded shank configured to be received within the aperture of the first member and the offset V-shape track of the second member; and the offset V-shape track configured for the pin to travel therein for translation and rotation of the first member relative to the second member.

The second member medial portion may be defined by a first side adjacent to the second member handle and opposite a second side adjacent to the second member tip, a top side extending between the first side and the second side, and a bottom side opposite the top side; the offset V-shape track may have a stem with a stem distal end, a bar with a bar distal end, and a junction where the stem and bar intersect; the stem extending from the junction to the stem distal end and substantially parallel with the second member tip and positioned near and along the top side of the second member medial portion with the stem distal end portion near the second side; and the bar extending from the junction towards the intersection of the bottom side and the second side.

The stem distal end portion may have a semi-circular notch extending towards the bottom side. The bar distal end portion may have a circular terminus. The first member tip may extend from the first member medial portion substantially aligned with the straight sides of the aperture of the first member.

Additionally or alternatively, the first member tip and the second member tip may be configured for engaging a snap-ring. If so, the pliers may be configured to be switchable for engaging both external snap-rings and internal snap-rings.

The pin may have a shank extending from a head, the shank has a length along which two substantially parallel opposing flat surfaces extend adjacent to two threaded portions. If so, the pliers may further include a nut engageable with the threaded portions of the pin.

Another aspect of the invention provides a method for converting a pliers from a first orientation to a second orientation, the method may include the steps of: providing a first member with a first member handle, a first member tip, and a first member medial portion between the first member handle and the first member tip, where the first member medial portion has an aperture comprising two opposed outwardly curved sides connected by two opposed straight sides; providing a second member with a second member handle, a second member tip, and a second member medial portion between the second member handle and the second member tip, where the second member medial portion has an offset V-shape track with a first distal end, a second distal end, and a junction; providing a pin with a threaded shank, where the shank of the pin has a length along which two substantially parallel opposing flat surfaces extend adjacent to two threaded portions, the shank received within and extending through the offset V-shape track of the second member and the aperture of the first member, wherein the flat surfaces of the shank are adjacent to the straight sides of the aperture, wherein the pin is retained within the aperture, and the offset V-shape track configured for the pin to travel therein and provide translation and rotation of the first member relative to the second member; starting with the pin in the first distal end of the offset V-shape track; moving the second member relative to the first member, whereby the pin is moved from the first distal end of the V-shape track to the junction of the V-shape track; rotating the second member relative to the first member; and moving the second member relative to the first member, whereby the pin is moved from the junction of the V-shape track to the second distal end of the V-shape track.

The V-shape track first distal end may have a semi-circular notch. The V-shape track second distal end may have a circular terminus.

The first orientation may be one for use with an internal or external snap-ring and the second orientation may be one for use with an external or internal snap-ring, respectively.

### BRIEF DESCRIPTION OF THE DRAWINGS

FIG. 1 is a perspective view of the pliers according to the present invention.

FIG. 2 is an exploded view of the pliers of FIG. 1.

FIG. 3A is a perspective view of the pliers of FIG. 1 with an external snap-ring.

FIG. 3B is a perspective view of the pliers of FIG. 1 in use.

FIG. 3C is an enhanced partial cut-away view of the pliers of FIG. 3A.

FIGS. 4A-4E illustrate a cut-away view of the pliers shown in FIG. 3A along line 4A-4E-4A-4E converting from an external snap-ring pliers to an internal snap-ring pliers.

FIG. 5A is a perspective view of the pliers of FIG. 1 engaged with an internal snap-ring.

FIG. 5B is a perspective view of the pliers of FIG. 5B in use.

FIG. 5C is an enhanced partial cut-away view of the pliers of FIG. 5A.

FIG. 6 is a perspective view of a second configuration of the pliers according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

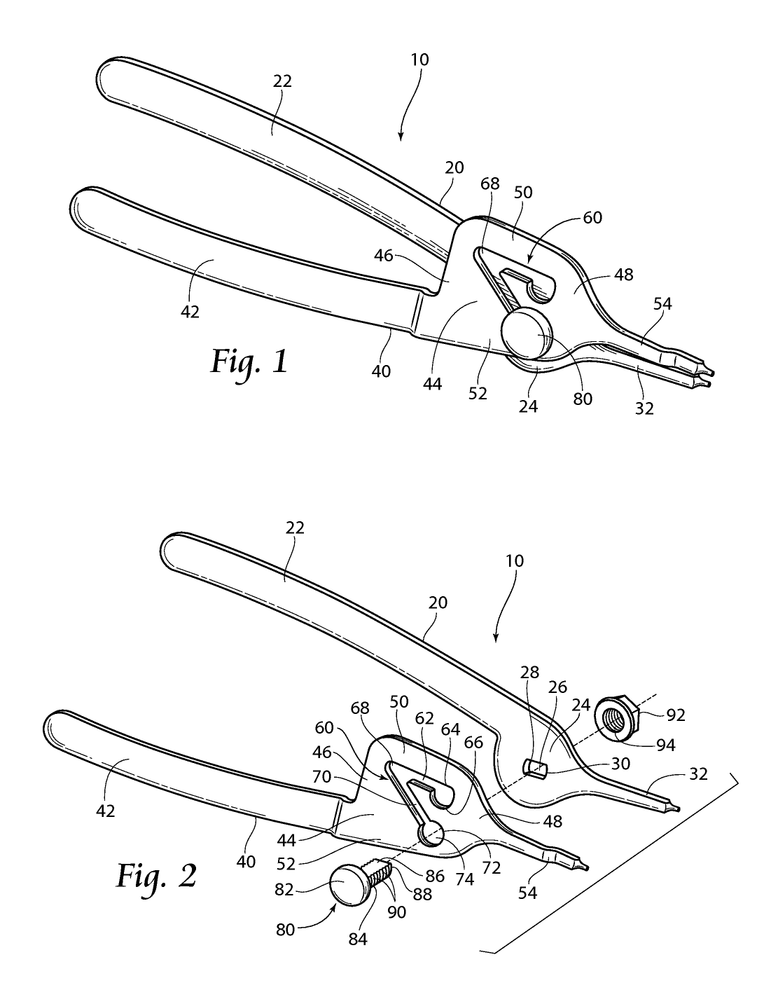

FIG. 1 illustrates a switchable pliers 10 according to the present invention. The pliers 10 comprises a first member 20, a second member 40, a pivot pin 80, and a nut 92.

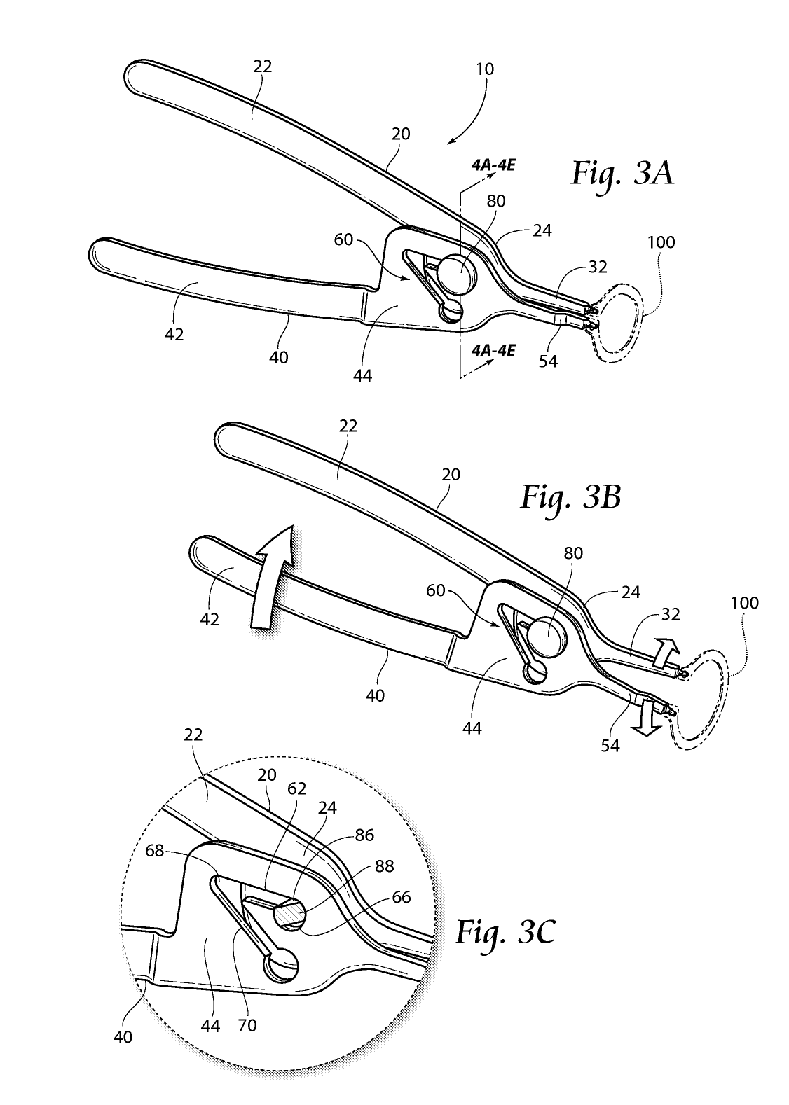

Continuing to look at FIG. 1 and further at FIG. 2, the first member 20 is shown comprising a first member handle 22 adjoining a first member medial portion 24 which adjoins a first member tip 32. According to the embodiment shown here, the first member handle 22 adjoins the first member medial portion 24 tangentially and the first member tip 32 preferably extends radially outward from the first member medial portion 24. Further, the first member handle 22 and the first member tip 32 are preferably not parallel.

The first member medial portion 24 comprises a pivot pin aperture 26 located approximately near the center of the first member medial portion 24. The pivot pin aperture 26 is preferably shaped like a rectangle having straight sides 28 which are the longer sides of the rectangle and substantially aligned with the first member tip 32, and two round sides 30, which are the two shorter sides. The two round sides 30 are preferably curved outward.

Still looking at FIGS. 1 and 2, the second member 40 is shown. The second member 40 comprises a second member handle, a second member medial portion, and a second member tip 54. The second member medial portion further comprises a first side 46, a second side 48 opposite the first side 46, a top side 50 adjacent the first and second sides 46 and 48, and a bottom side 52 opposite the top side 50. It should be understood that any reference to orientation (i.e., top side and bottom side) is employed for ease of describing the present invention as shown in FIGS. 1-5C.

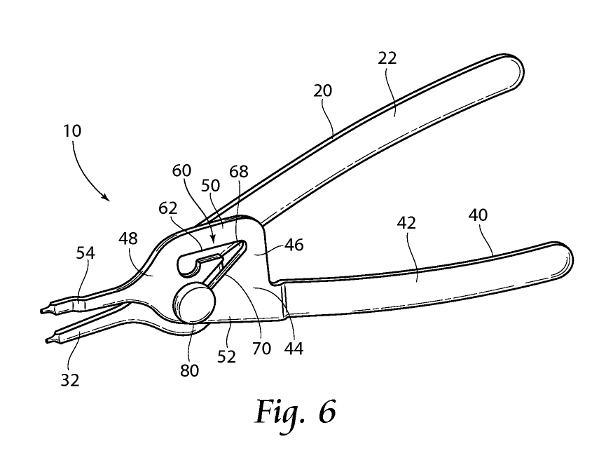

Additionally or alternatively, it is contemplated that the second member 40 may be flipped with respect to the first member 20, as shown in FIG. 6, and still be within the scope of the invention.

The second member handle 42 preferably extends from the medial portion first side 46 along the medial portion bottom side 52. The second member tip 54 preferably adjoins the second member medial portion 44 on the medial portion second side 48, at a location between the top side 50 and the bottom side 52, and preferably approximately the midpoint between the top side 50 and the bottom side 52, and extends in substantially the opposite direction of the second member handle 42.

Continuing to look at FIGS. 1 and 2, a V-shape track 60 is shown in the area defined by the second member medial portion first side 46, second side 48, top side 50, and bottom side 52. The V-shape track 60 is preferably in the shape of an offset “V”. The letter “V” can be described as having a stem and a bar, whereby the stem is the primary diagonal line and the bar depends upward from the bottom of the stem, or junction. As depicted in the Figures here, the parts of the V-shape track 60 will be designated as follows: part number 62 will designate the stem of the V-shape track 60 and part number 70 will designate the bar of the V-shape track 60, and part number 68 will designate the junction of the stem and the bar.

The stem 62 is preferably positioned closer to the top side 50 than the bottom side 52 of the second member medial portion 44, and substantially parallel with the second member tip 54. The stem 62 and bar 70 are connected nearest the corner of the top side 50 and the first side 46 of the second member medial portion 44 with the stem 62 extending toward the second side 48 at which the stem 62 terminates at a stem distal end portion 64 positioned nearest the corner of the top side 50 and the second side 48. The stem distal end portion 64 comprises a semi-circular notch 66; whereby the curved portion of the semi-circular notch 66 extends in the direction of the second side 48.

The bar 70 of the V-shape track 60 is offset from the stem 62 and extends from the corner of the top side 50 and the first side 46 towards the corner of the bottom side 52 and the second side 48, near which the bar terminates at a bar distal end portion 72. The bar distal end portion 72 preferably comprises a circular terminus 74.

The pivot pin 80 comprises a head 82 and a shank 84. The shank 84 comprises two opposing threaded portions 88 with external threads 90 and two opposing non-threaded contact surfaces 86, all extending along the length of the shank. Preferably, the two contact surfaces 86 are flat. The profile of the shank 84, including the outer diameter of the threaded portions 88, therefore looks like opposing letter D's with flat lines extending between the tops and the bottoms of the D's, substantially similar to the shape of the pivot pin aperture 26.

The pivot pin 80 is secured in place by inserting the pivot pin 80 through the V-shape track 60 and the pivot pin aperture 26, with the contact surfaces 86 of the pivot pin shank 84 aligned with the straight sides 28 of the pivot pin aperture 26 and the threaded portions 88 of the pivot pin shank 84 aligned with the round sides 30 of the pivot pin aperture 26, and engaging the pivot pin external threads 90 with the internal threads 94 of the nut 92.

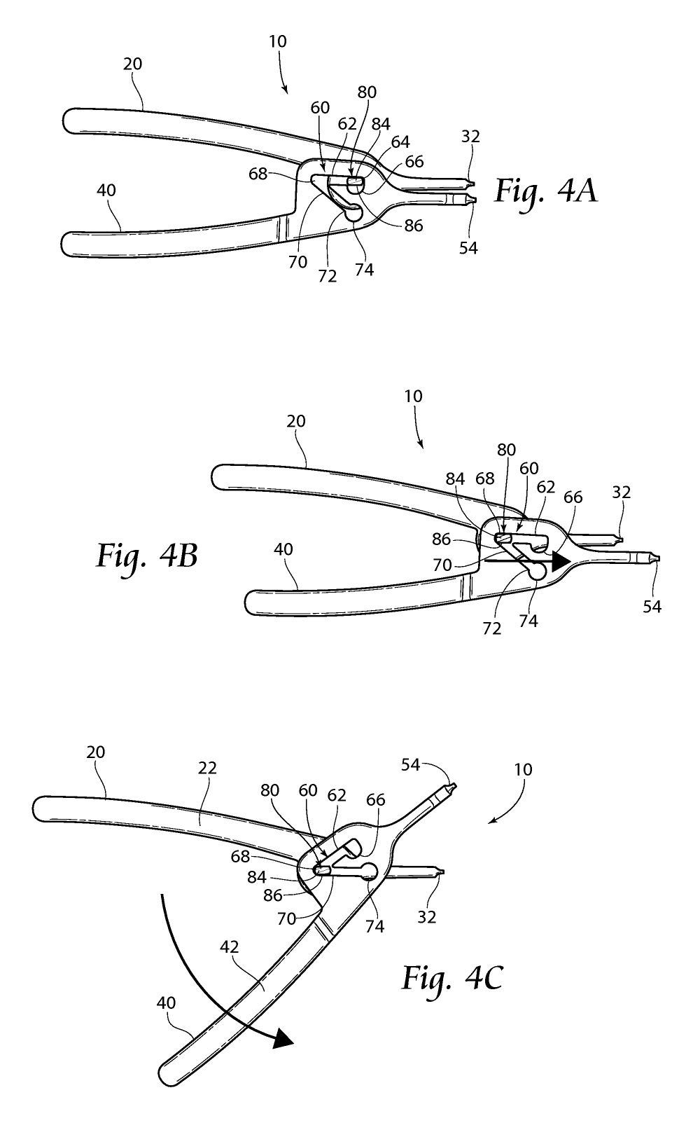

FIGS. 3A-3C illustrate the pliers 10 engaged with an external snap-ring 100. The pivot pin 80 is positioned in the semi-circular notch 66, and the first member handle 22 and the first member tip 32 are both on the same side of the second member handle 42 and the second member tip 54, respectively, with the first and second member tips 32 and 54 adjacent to one another.

Moving the first and second member handles 22 and 42 closer together translates into the moving apart of the first member tip 32 and the second member tip 54, as the first and second members 20 and 40 rotate about the pivot pin 80. As shown in FIG. 3, the external snap-ring is biased open.

FIG. 3C illustrates a close-up and cut-away view of the position of the pivot pin shank 84 in the semi-circular notch 66 and with respect to the stem 62 of the V-shape track 60 of the pliers in the orientation shown in FIG. 3A. The contact surfaces 86 are not in alignment with the stem 62 in this orientation, and, when the pliers 10 are employed as shown in FIG. 3B, the pivot pin 80 rotates counter-clockwise relative to, and further away from, the stem 62, thereby decreasing the likelihood of the first and second members 20 and 40 moving laterally relative to each other and disengaging from the external snap-ring 100.

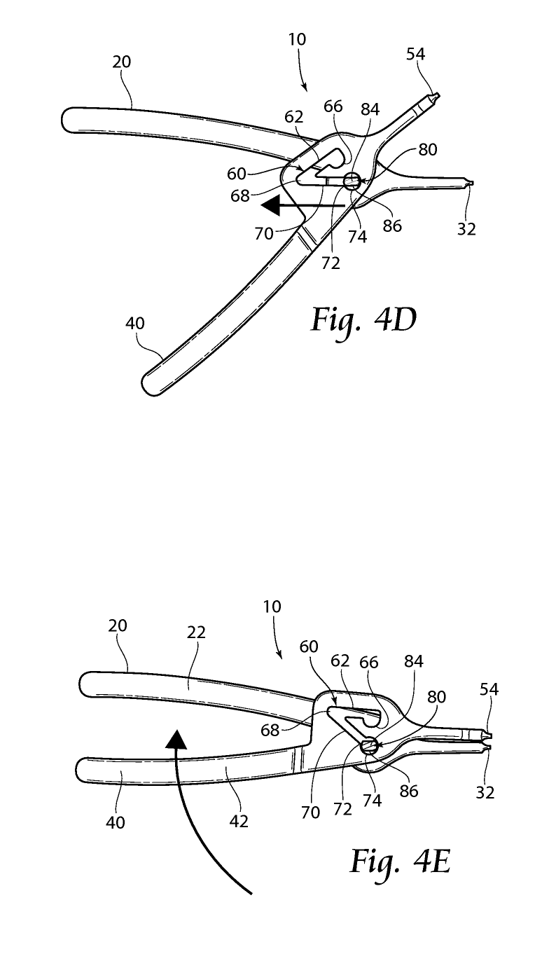

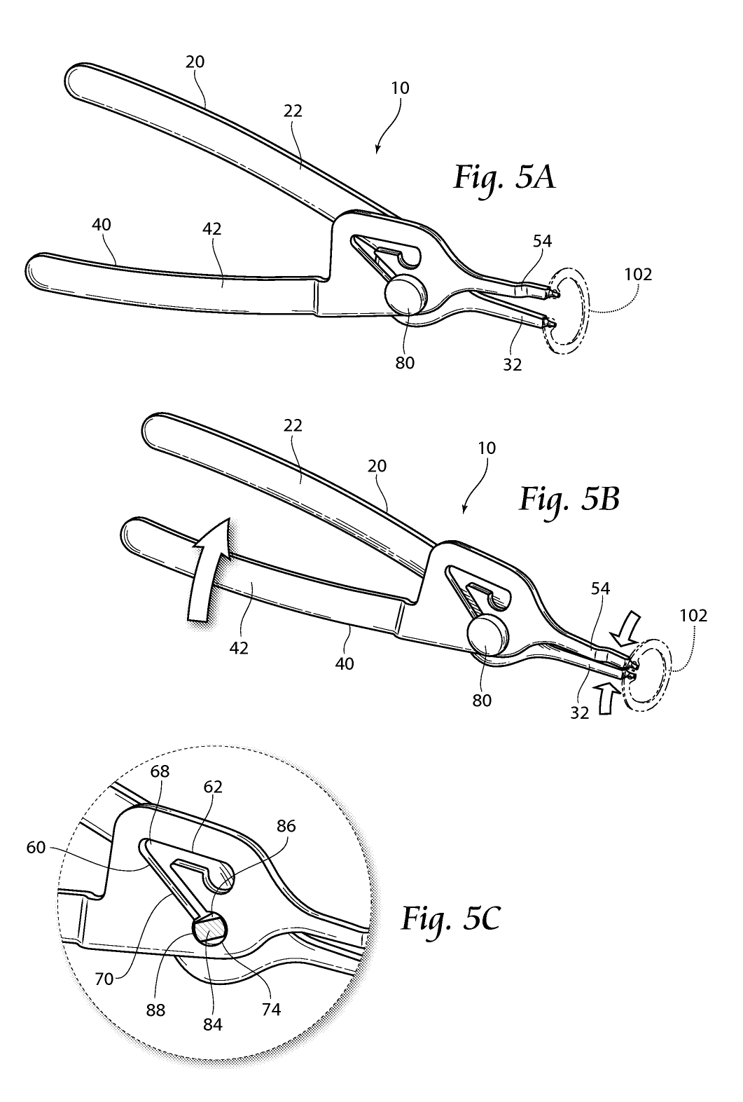

FIGS. 4A-4E illustrate the conversion of the pliers 10 from operable with an external snap-ring 100, as shown in FIG. 3A, to operable with an internal snap-ring 102, as shown in FIG. 5A. First, starting with the pliers 10 in the external snap-ring orientation as shown in FIG. 3A, the pivot pin 80 is moved from the semi-circular notch 66 to an aligned position wherein the contact surfaces 86 of the pivot pin shank 84 are in-line with the stem 62 of the V-shape track 60 at the stem distal end portion 64, as shown in FIG. 4A.

As shown in FIG. 4B, the pivot pin 80 is moved along the stem 62 towards the junction 68. The movement may be accomplished by moving the second member relative to the first member 20 in the direction shown.

The second member handle 42 may then be rotated away from the first member handle 22 about the pivot pin 80 until the contact surfaces 86 of the pivot pin shank 84 substantially align with the bar 70 of the V-shape track 60. In this configuration, the second member tip 54, which is shown here as being offset, is able to pass around to the other side of the first member tip 32.

The second member 40 may then be moved relative to the first member 20 in the direction of the arrow shown in FIG. 4D until the pivot pin shank 84 is substantially within the circular terminus 74 at the bar distal end portion 72 of the bar 70.

FIG. 4E shows the conclusion of the conversion of the pliers 10 from use with external snap-rings 100 to use with internal snap-rings 102 by rotating the second member handle 42 about the pivot pin 80 towards the first member handle 22.

Now in the internal snap-ring orientation, FIGS. 5A-5C show the pliers 10 in use with an internal snap-ring 102. FIG. 5A illustrates the pliers 10 as it would be positioned when approaching an internal snap-ring 102. The first member handle 22 and the first member tip 32 are on opposite sides of the second member handle 42 and the second member tip 54, respectively. Once engaged with the internal snap-ring 102 the first and second member handles 22 and 42 may be moved towards each other as shown in FIG. 5B. This motion causes the first and second member tips 32 and 54 to also move towards each other as the first and second members 20 and rotate about pivot pin 80 due to the cross-over configuration of the pliers in the internal snap-ring orientation. The internal snap-ring is thus biased inwards and allowed to be installed or removed.

FIG. 5C illustrates a close-up and cut-away view of the position of the pivot pin shank 84 in the circular terminus 74 and with respect to the bar 70 of the V-shape track 60 of the pliers in the orientation shown in FIG. 5A. The contact surfaces 86 are not in alignment with the bar 70 in this orientation, and, when the pliers 10 are employed as shown in FIG. 5B, the pivot pin 80 rotates counter-clockwise relative to, and further away from, the bar 70, thereby decreasing the likelihood of the first and second members 20 and 40 moving laterally relative to each other and disengaging from the internal snap-ring 102.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A pliers comprising:
a first member with a first member handle, a first member tip, and a first member medial portion between the first member handle and the first member tip;
the first member medial portion has an aperture comprising two opposed outwardly curved sides connected by two opposed straight sides;
a second member with a second member handle, a second member tip, and a second member medial portion between the second member handle and the second member tip;
the second member medial portion has an offset V-shape track;
a pin with a threaded shank configured to be received within the aperture of the first member and the offset V-shape track of the second member; and
the offset V-shape track configured for the pin to travel therein for translation and rotation of the first member relative to the second member.

2. The pliers of claim 1, wherein the second member medial portion is defined by a first side adjacent to the second member handle and opposite a second side adjacent to the second member tip, a top side extending between the first side and the second side, and a bottom side opposite the top side;
the offset V-shape track comprises a stem with a stem distal end, a bar with a bar distal end, and a junction where the stem and bar intersect;
the stem extends from the junction to the stem distal end and is substantially parallel with the second member tip and positioned near and along the top side of the second member medial portion with the stem distal end portion near the second side; and
the bar extends from the junction towards the intersection of the bottom side and the second side.

3. The pliers of claim 2, wherein the stem distal end portion has a semi-circular notch extending towards the bottom side.

4. The pliers of claim 2, wherein the bar distal end portion has a circular terminus.

5. The pliers of claim 2, wherein:
the first member tip extends from the first member medial portion substantially aligned with the straight sides of the aperture of the first member.

6. The pliers of claim 1, wherein the first member tip and the second member tip are configured for engaging a snap-ring.

7. The pliers of claim 6 configured to be switchable for engaging both external snap-rings and internal snap-rings.

8. The pliers of claim 1, wherein the pin comprises a shank extending from a head, the shank has a length along which two substantially parallel opposing flat surfaces extend adjacent to two threaded portions.

9. The pliers of claim 8, further comprising a nut engageable with the threaded portions of the pin.

10. A method for converting a pliers from a first orientation to a second orientation, the method comprising the steps of:
providing a first member with a first member handle, a first member tip, and a first member medial portion between the first member handle and the first member tip;
where the first member medial portion has an aperture comprising two opposed outwardly curved sides connected by two opposed straight sides;
providing a second member with a second member handle, a second member tip, and a second member medial portion between the second member handle and the second member tip;
where the second member medial portion has an offset V-shape track with a first distal end, a second distal end, and a junction;
providing a pin with a threaded shank;
where the shank of the pin has a length along which two substantially parallel opposing flat surfaces extend adjacent to two threaded portions and is received within and extends through the offset V-shape track of the second member and the aperture of the first member, wherein the flat surfaces of the shank are adjacent to the straight sides of the aperture, wherein the pin is retained within the aperture;
where the offset V-shape track is configured for the pin to travel therein and provide translation and rotation of the first member relative to the second member;
starting with the pin in the first distal end of the offset V-shape track;
moving the second member relative to the first member, whereby the pin is moved from the first distal end of the V-shape track to the junction of the V-shape track;
rotating the second member relative to the first member; and
moving the second member relative to the first member, whereby the pin is moved from the junction of the V-shape track to the second distal end of the V-shape track.

11. The method of claim 10, wherein the V-shape track first distal end comprises a semi-circular notch.

12. The method of claim 10, wherein the V-shape track second distal end comprises a circular terminus.

13. The method of claim 10, wherein the first orientation is one for use with an internal or external snap-ring and the second orientation is one for use with an external or internal snap-ring, respectively.
